(19) United States
(12) Patent Application Publication
(10) Pub. No.: US 2016/0050379 A1
(43) Pub. Date: Feb. 18, 2016

(54) Curved Light Sensor

(71) Applicant: Apple Inc., Cupertino, CA (US)

(72) Inventors: Tongbi T. Jiang, Cupertino, CA (US); Xiaofeng Fan, Cupertino, CA (US)

(21) Appl. No.: 14/462,032

(22) Filed: Aug. 18, 2014

(51) Int. Cl. H04N 5/372; H04N 5/225

(52) U.S. Cl. CPC H04N 5/372; H04N 5/2253

(57) ABSTRACT

An optical system can include a curved light sensor and an optical system positioned in front of the curved light sensor. The curved light sensor includes a substrate and a patterned stress film formed over at least surface of the substrate.

### TECHNICAL FIELD

The present invention relates generally to optical systems, and more particularly to light sensors used in optical systems. Still more particularly, the present invention relates to a curved light sensor that may be included in an optical system.

### BACKGROUND

Optical systems, such as image capture systems, are included in a variety of electronic devices, such as digital cameras, cellular telephones, digital media players, computers, and tablet computing systems. An image capture system often uses one or more image sensors, such as a CCD image sensor or a CMOS image sensor, to capture images and video. FIG. 1 is a simplified block diagram of an image capture system according to the prior art. An image sensor 100 includes a large number of pixels formed in a pixel array on the surface 102 of a substrate. Typically, an optical system 104 is positioned in front of the image sensor 100 to focus or direct light 106 onto the pixel array. When light is incident on the pixel array, the image sensor converts the light captured by the pixels into electrical signals to capture an image.

The flat surface 102 of the image sensor 100 may narrow the field of light that can be received by the pixel array. The optical system 104 compensates for this narrow field of view by including multiple lenses that widen the field of view and flatten the image onto the flat surface of the image sensor. The optical system may also correct for aberrations in an image that can result from the flat surface 102. However, the type and number of lenses used in an optical system can increase the complexity of the optical system 104. A complex optical system may increase the cost, size, and weight of the image capture system, which in turn may make an electronic device that includes the image capture system more expensive.

### SUMMARY

In one aspect, a curved light sensor includes a light sensor and a patterned stress film formed over at least one surface of the light sensor. As used herein, the term “light sensor” is meant to be construed broadly, and therefore should be interpreted to include light emitting sensors and light detection sensors. Example light emitting sensors include, but are not limited to a light-emitting diode (LED) sensor, an organic LED sensor, and vertical-cavity, surface emitting laser. Example light detection sensors include, but are not limited to, CMOS image sensors, and light sensors that include optical detectors or photodetectors such as photodiodes and photoresistors.

In one embodiment, the patterned stress film is formed over a non-light receiving surface of the light sensor. In another embodiment, the patterned stress film is formed over the light receiving surface of the light sensor. As one example, a patterned stress film can be formed around a periphery of the sensor or pixel array. And in yet another embodiment, a patterned stress film can be formed over both the light receiving surface and the non-light receiving surface of the light sensor.

The patterned stress film can include a single layer of a stress film or multiple layers of stress films. When multiple layers of stress films are formed over a surface of the image sensor, at least one layer of a stress film in the multiple layers of stress films can be a different type of stress film than another layer of a stress film in the multiple layers of stress films. Additionally or alternatively, at least one layer of a stress film in the multiple layers of stress films may be patterned differently than another layer of a stress film in the multiple layers of stress films. As one example, one stress film layer may not be patterned while another stress film layer is patterned. As another example, one stress film layer may be patterned in a first pattern while another stress film layer is patterned in a different second pattern.

An optical system in optical communication with the curved light sensor may be designed to complement the curved light sensor. The components included in the optical system can be selected and/or constructed to optimize the amount of light that is incident on the light receiving surface. In some embodiments, a fewer number of components may be used in the optical system compared to prior art optical systems due to the curved light sensor and the radius of curvature of the light sensor. In another aspect, a method for producing a curved light sensor can include attaching a support wafer to a first surface of a sensor wafer and forming a stress film over a second surface of the sensor wafer. In some embodiments, the sensor wafer is thinned to a given thickness before the stress film is formed over the second surface of the sensor wafer. The sensor wafer includes multiple light sensors, such as, for example, multiple image sensors, and a pattern is formed in the stress film over each light sensor. An optional dicing die attach film can be attached over the patterned stress film. The support wafer may then be removed from the first surface of the sensor wafer. The light sensors are then singulated. Each curved light sensor includes a respective patterned stress film over the second surface. In some embodiments the patterned stress film is positioned between the dicing die attach film and the surface of the light sensor.

In some embodiments, a stress film is formed over the first surface of the sensor wafer and patterned prior to thinning the sensor wafer and/or prior to attaching the support wafer to the first surface of the sensor wafer. The stress film can include one or more layers of the same or of different types of a stress film.

In yet another aspect, a method for producing a curved light sensor can include attaching a dicing tape to a first surface of a sensor wafer and forming a stress film over a second surface of the sensor wafer. In some embodiments, the sensor wafer is thinned to a given thickness before the stress film is formed over the second surface of the sensor wafer. A pattern is formed in the stress film over each light sensor. The light sensors are singulated, and the dicing tape is then removed. Each curved light sensor includes a respective patterned stress film over the second surface of the light sensor.

In some embodiments, a stress film is formed over the first surface of the sensor wafer and patterned prior to thinning the sensor wafer and/or prior to attaching the support wafer to the first surface of the sensor wafer. The stress film can include one or more layers of the same or of different types of a stress film.

### BRIEF DESCRIPTION OF THE DRAWINGS

Embodiments of the invention are better understood with reference to the following drawings. The elements of the drawings are not necessarily to scale relative to each other. Identical reference numerals have been used, where possible, to designate identical features that are common to the figures.

FIG. 1 is a simplified block diagram of an optical system according to the prior art;

FIG. 2 is a simplified block diagram of an optical system that includes a curved light sensor;

FIG. 3 is a plan view of a patterned stress film over a surface of an image sensor;

FIG. 4 is a flowchart of one example method for producing a curved image sensor;

FIG. 5 is a flowchart of a first method that is suitable for block 402 in FIG. 4;

FIGS. 6A-6G illustrate the method shown in FIG. 5;

FIG. 7 is a flowchart of a second method that is suitable for block 402 in FIG. 4;

FIGS. 8A-8G illustrate the method shown in FIG. 7;

FIG. 9 depicts one example of a patterned stress film formed over a sensor wafer;

FIG. 10 illustrates one example of different patterned stress films formed over a sensor wafer;

FIG. 11 is a block diagram of an electronic device that may include the image capture system shown in FIG. 2; and

FIGS. 12 and 13 are front and rear perspective views of an example electronic device that can include one or more curved image sensors.

### DETAILED DESCRIPTION

Embodiments described herein provide a curved light sensor and methods for fabricating a curved light sensor. The substrate of a curved light sensor has a given radius of curvature. An optical system that directs or focuses light onto the curved light sensor can be designed to complement the curved light receiving surface of the curved light sensor. The optical system may use fewer components based on the curved light sensor. Thus, the curved light sensor can reduce the complexity of an optical system because fewer lenses and/or other components may be used in the optical system. The reduced complexity may lower the cost of the optical system and of the optical system. Additionally or alternatively, a curved light sensor can reduce the z-height of an optical system, which can be advantageous for thinner electronic devices such as cellular telephones, tablet computing devices, and digital media players.

A curved light sensor includes one or more layers of a stress film on at least one surface of the light sensor. A layer or layers of the stress film may be patterned to have a pattern that creates a desired stress imbalance in the sensor substrate. As used herein, the term “stress film” is meant to encompass one or more layers of the same or different stress films. The pattern in the stress film can produce different compressive and/or tensile stresses that cause the image sensor substrate to bend or curve. The pattern in the stress film is designed to produce a predetermined or given radius of curvature in the substrate.

Directional terminology, such as “top”, “bottom”, “front”, “back”, “leading”, “trailing”, etc., is used with reference to the orientation of the Figure(s) being described. Because components in various embodiments can be positioned in a number of different orientations, the directional terminology is used for purposes of illustration only and is in no way limiting. When used in conjunction with layers of a sensor wafer, light sensor die, or corresponding light sensor, the directional terminology is intended to be construed broadly, and therefore should not be interpreted to preclude the presence of one or more intervening layers or other intervening light sensor features or elements. Thus, a given layer that is described herein as being formed on, formed over, disposed on, or disposed over another layer may be separated from the latter layer by one or more additional layers.

Additionally, the terms “sensor wafer” and “substrate” are to be understood as a semiconductor-based material including, but not limited to, silicon, silicon-on-insulator (SOI) technology, silicon-on-sapphire (SOS) technology, doped and undoped semiconductors, germanium, gallium arsenide (GaAs), and gallium nitride (GaN) semiconductors, epitaxial layers formed on a semiconductor substrate, well regions or buried layers formed in a semiconductor substrate, and other semiconductor structures.

Embodiments are described herein in conjunction with an image sensor and a sensor wafer that includes multiple image sensors. Other embodiments, however, are not limited to image sensors. As previously described, other types of light sensors can be employed in other embodiments. The light sensors include light emitting sensors and light detection sensors.

Referring now to FIG. 2, there is shown a simplified block diagram of an optical system. In particular, the illustrated embodiment is an image capture system. The image capture system 200 includes an optical system 202 that is in optical communication with a curved image sensor 204. The optical system 202 may include conventional elements such as one or more lenses, a filter, an iris, and a shutter. The optical system 202 directs, focuses, or transmits light 206 onto a light receiving surface 208 of the curved image sensor 204. The curved image sensor 204 captures one or more images of a subject scene by converting the incident light into electrical signals.

The curved image sensor 204 includes an image sensor 210 and a stress film 212. As described earlier, the stress film 212 can include one or more layers of the same or different stress films. In the illustrated embodiment, the stress film 212 is formed over a non-light receiving surface 214 of the image sensor 210. Other embodiments can include a stress film over the light receiving surface only, or on both the light receiving surface and the non-light receiving surface of an image sensor. The stress film 212 produces a desired curve or bend in the image sensor. The stress film 212 creates a given radius of curvature in the image sensor.

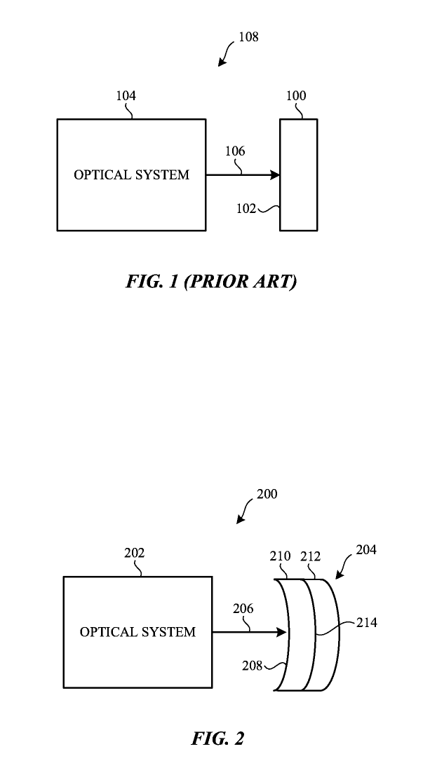

The optical system 202 may be designed to complement the curved image sensor 204. The components included in the optical system can be selected and/or constructed to optimize the amount of light that is incident on the light receiving surface 208. In some embodiments, a fewer number of components may be used in the optical system 202 compared to the prior art optical system 104 (FIG. 1) based on the curved image sensor and the radius of curvature of the image sensor. A decreased number of components may also reduce the complexity of the optical system 202, and/or the type or design of a component in the optical system 202.

In some embodiments, the pixels or light sensitive elements in the light receiving surface can have a uniform pitch and/or size. In other embodiments, the pitch and/or size of the light sensitive elements can be non-uniform across the light receiving surface. For example, the light sensitive elements can have a first pitch and/or size along the edge of the pixel array and a different second pitch and/or size in the central area of the image sensor. Other embodiments can design the pitch and/or size of the light sensitive elements in any suitable configuration.

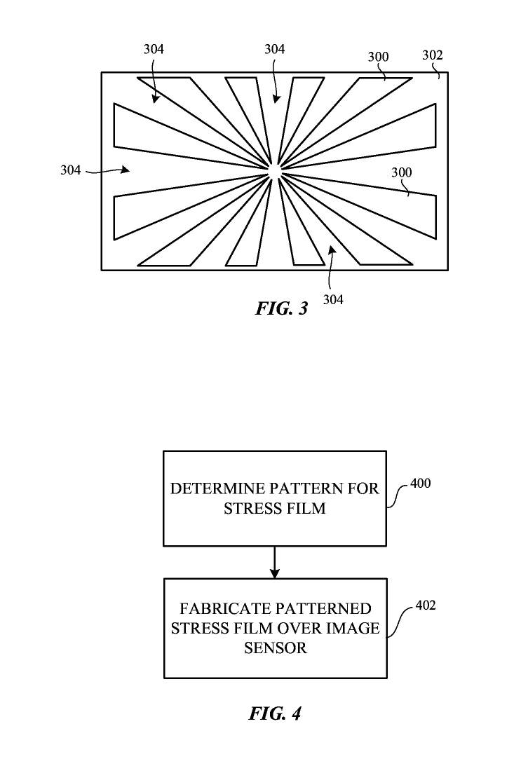

FIG. 3 is a plan view of a patterned stress film over a surface of an image sensor. The illustrated patterned stress film 300 is formed over a non-light receiving surface 302 of an image sensor. The stress film is patterned such that certain regions 304 of the non-light receiving surface 302 are not overlaid with the stress film 300. The pattern of the stress film 300 is designed to produce a stress imbalance in the image sensor by producing different compressive and/or tensile stresses that cause the image sensor substrate to bend or curve to the desired or given shape.

Referring now to FIG. 4, there is shown a flowchart of one example method for producing a curved image sensor. Initially, the pattern(s) for the one or more layers of the stress film is determined at block 400. In one embodiment, the pattern or patterns of the stress film may be determined through simulation based on a desired radius of curvature. For example, the radius of curvature (r) can be estimated using the Stoney equation:

$$r = \frac{{E}_{s} \cdot {t}_{s}^{2}}{{( 1 - v )}_{s} \cdot 6 \cdot {σ}_{f} \cdot {t}_{f}} , \qquad Equation 1$$

where v represents Poisson's ratio, E represents Young's modulus, tₛ is the thickness of the image sensor substrate, t_{f} is the thickness of the stress film, and σ_{f} represents the stress of the stress film. In one embodiment, the substrate of the image sensor is a silicon substrate, and vₛᵢ=0.272 and Eₛᵢ=190 GPa for silicon. It should be noted that use of the Stoney equation is not required and other embodiments can determine the radius of curvature differently.

Next, as shown in block 402, the patterned stress film is fabricated over at least one surface of the image sensor substrate or sensor wafer. In one example, the patterned stress film is fabricated over the non-light receiving surface of the image sensor substrate. Additionally or alternatively, a patterned stress film can be fabricated over the light receiving surface of the image sensor substrate. As one example, the patterned stress film can be formed around a periphery of the pixel array in an image sensor.

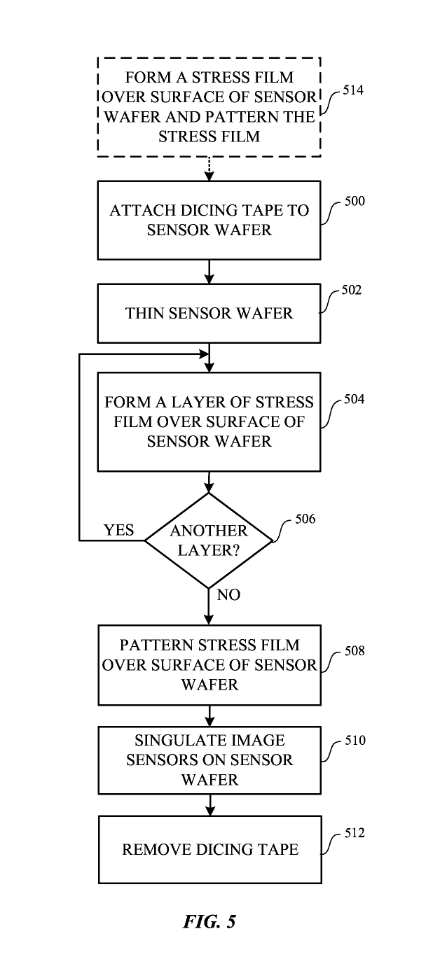

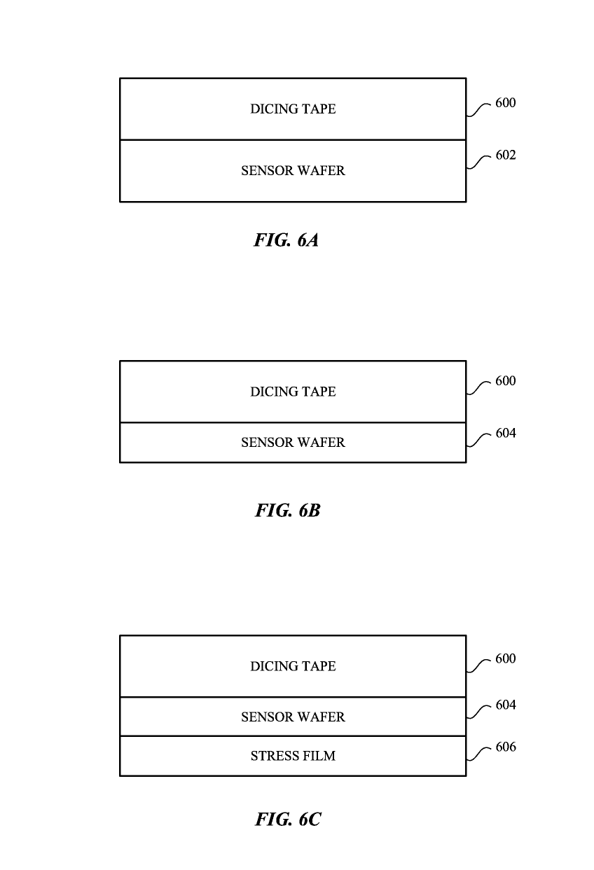

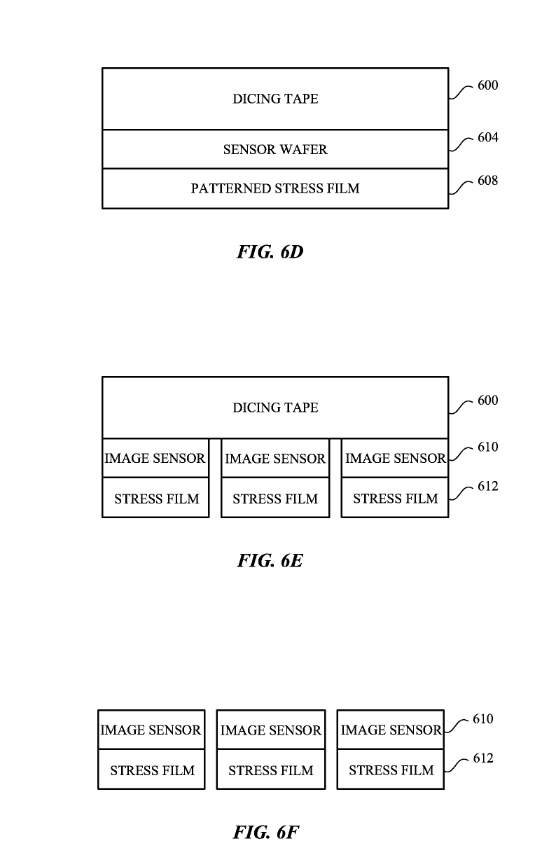

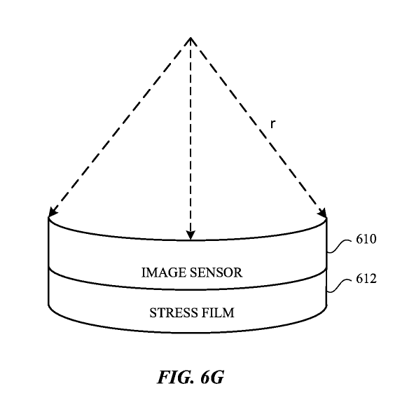

FIG. 5 is a flowchart of a first method that is suitable for block 402 in FIG. 4. The illustrative blocks in FIG. 5 are described in conjunction with FIGS. 6A-6G. Initially, a dicing tape can be attached to a sensor wafer at block 500. Any suitable dicing tape can be used. As one example, a pressure sensitive adhesive dicing tape or an ultraviolet (UV) adhesive dicing tape may be attached to a sensor wafer.

FIG. 6A depicts a dicing tape 600 attached to a surface of the sensor wafer 602. The sensor wafer 602 may include multiple image sensors that are fabricated in and/or on the sensor wafer. For example, in the embodiment shown in FIG. 6A, the dicing tape 600 is attached to the surface of the sensor wafer 602 that corresponds to the light receiving surface of the image sensors.

The sensor wafer may then be thinned, as shown in block 502 (see FIG. 6B). In one embodiment, the sensor wafer 604 is thinned to have a thickness of ten to one hundred microns. Any suitable wafer thinning process may be used. For example, the sensor wafer can be thinned using a mechanical grinding process, a chemical mechanical polishing process, or a dry chemical etching process.

A layer of a stress film 606 is then formed over a surface of the thinned sensor wafer 604 (block 504 and FIG. 6C). As one example, in the embodiment shown in FIG. 6C, the layer of the stress film 606 is formed over a surface of the sensor wafer that corresponds to the non-light receiving surface of the image sensors. Any suitable type of stress film may be used. As one example, a plasma enhanced chemical vapor deposition (PECVD) silicon nitride film may be formed over the surface of the thinned sensor wafer. A determination may then be made at block 506 as to whether or not another layer of a stress film is to be formed over a surface of the sensor wafer. If so, the process returns to block 504 and a layer of the same stress film or of a different stress film is formed over a surface of the sensor wafer.

The number of layers of stress films (e.g., the density) formed over one or more surfaces of the sensor wafer may be the same or may differ across each surface of the sensor wafer. Thus, the density of the stress film(s) can be customized for one or more image sensors on the sensor wafer. Additionally or alternatively, the density of the stress film can vary selectively at different locations on the sensor wafer. A particular region of the sensor wafer can have a different stress film density, and/or a specific region of one or more image sensors can have a different stress film density

When another layer of a stress film will not be formed over the sensor wafer, the method passes to block 508 where the stress film over the surface of the sensor wafer is patterned into a predetermined pattern (FIG. 6D). As described earlier, the pattern for the stress film (i.e., one or more layers of a stress film), or for an individual layer of a stress film can be based on a desired or given radius of curvature for the substrate of each image sensor. The pattern or patterns may be the same or may differ across the entire surface of the sensor wafer. Thus, the pattern of each stress film, or an individual layer of a stress film, can be customized for one or more image sensors on the sensor wafer.

Any suitable technique can be used to pattern the stress film or an individual layer of a stress film. As one example, a pattern can be formed in the stress film using photolithography. The pattern may be fabricated by etching the stress film or an individual layer of a stress film. In the embodiment of FIG. 5, if more than one layer of a stress film is formed over a surface of the image sensor, the multiple layers of stress films may be patterned at one time (e.g., etched at block 508). In another embodiment, a pattern can be formed in each individual layer after the layer is formed over the sensor wafer. And in yet another embodiment, a pattern can be formed in a select individual layer after the layer is formed over the sensor wafer and a pattern can be formed in multiple layers at one time. When multiple layers are patterned at one time, the layers may be patterned in a single patterning process or multiple patterning processes can be performed to pattern the layers. For example, if two layers of two different types of stress films are formed over a surface, the two layers can be patterned at the same time or individually depending on whether the two layers have the same or different patterns and/or depending on the process used to fabricate the pattern(s) in the two layers.

The image sensors on the sensor wafer are then singulated, as shown in block 510 and in FIG. 6E. Singulation is a process of dicing or cutting the sensor wafer to separate the image sensors in the sensor wafer into individual image sensors. Each image sensor 610 and associated patterned stress film 612 are produced after the sensor wafer is diced.

The dicing tape 600 may then be removed, as shown in block 512 (see FIG. 6F). As described earlier, the patterned stress film 612 produces a stress imbalance in the image sensor substrate, which causes the substrate to bend or curve. A curved image sensor is shown in FIG. 6G. As described earlier, the stress film 612 produces a predetermined or given radius of curvature (r) in the image sensor 610.

In embodiments where a stress film is to be formed over the surface that the dicing tape will attach to (e.g., the surface corresponding to the light receiving surfaces of the image sensors), a stress film can be formed over that surface of the sensor wafer and patterned at block 514 prior to attaching the dicing tape to the sensor wafer. The stress film can include one or more layers of the same or different types of a stress film. After the layer or layers of stress films have been formed over the surface and patterned, the method may pass to block 500.

Although the method of FIG. 5 is described as patterning all of the layers in a stress film, it will be appreciated that one or more layers of a stress film may not patterned when a stress film includes multiple layers. Thus, some but not all of the layers in the stress film may be patterned to produce the desired bend or curve in an image sensor. Additionally or alternatively, a single layer of stress film can be formed with two or more different types of stress films. As one example, one type of a stress film can be formed around the periphery of an image sensor and another type of stress film may be formed inside the periphery. The different types of stress films may or may not be patterned.

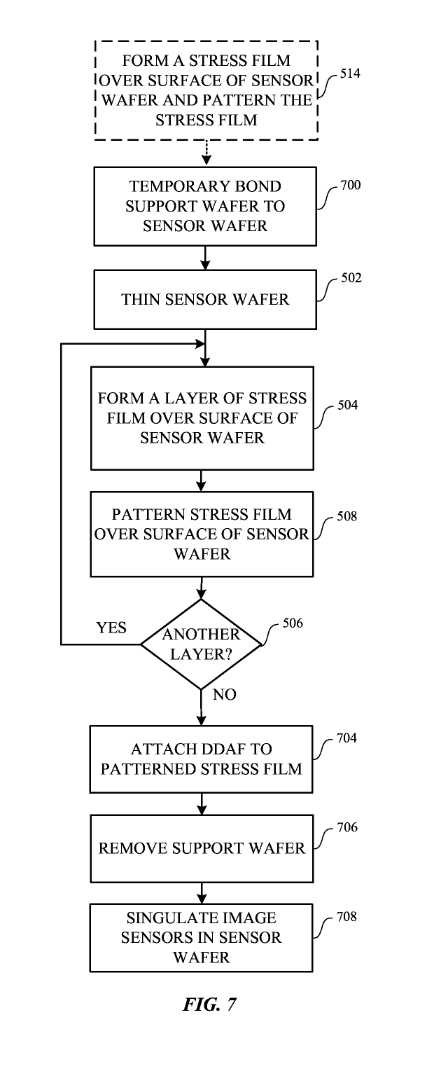

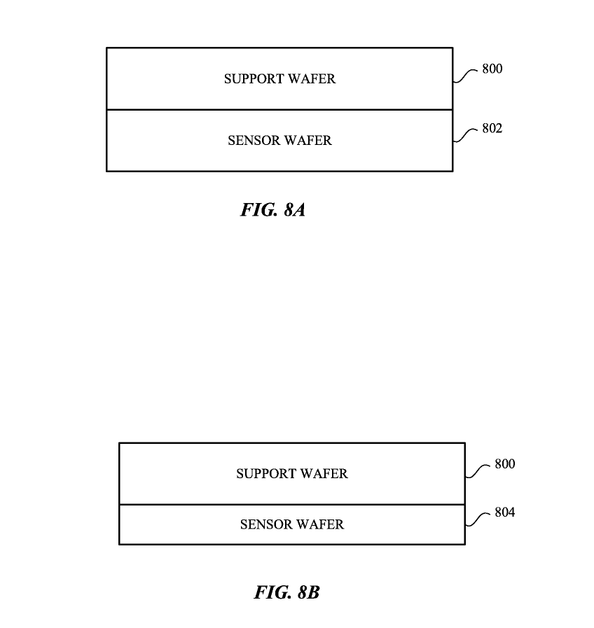

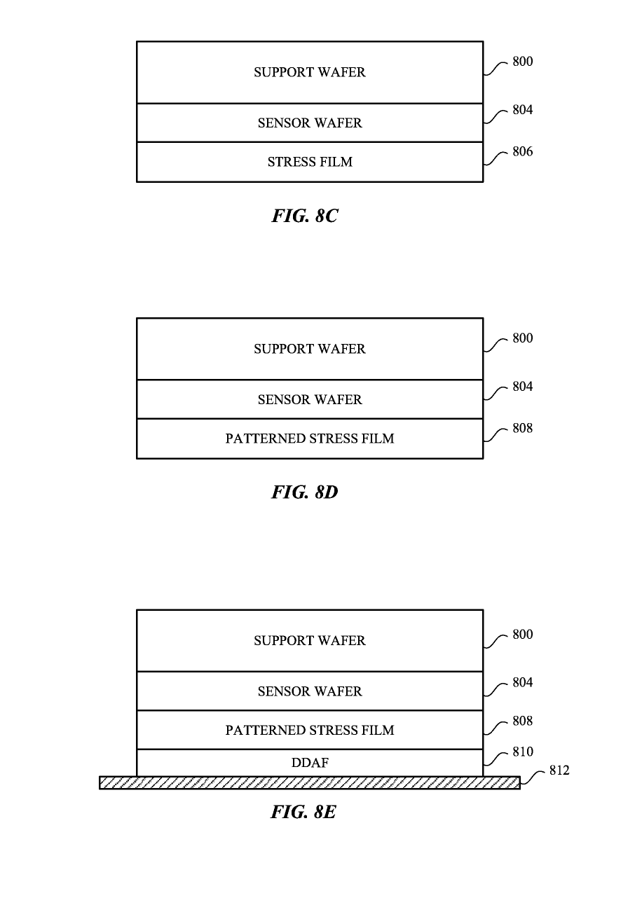

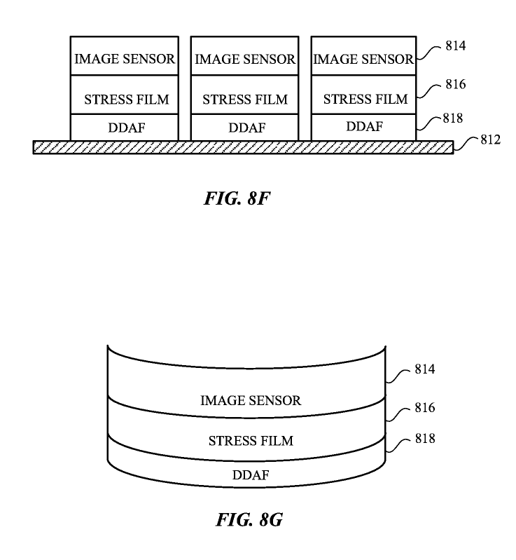

FIG. 7 is a flowchart of a second method that is suitable for block 402 in FIG. 4. The blocks shown in FIG. 7 are described in conjunction with FIGS. 8A-8G. Initially, a support wafer can be temporarily bonded to a sensor wafer at block 700. Any suitable type of a support wafer can be used. FIG. 8A depicts a support wafer 800 attached to a sensor wafer 802. As one example, the support wafer 800 is attached to the surface of the sensor wafer that corresponds to the light receiving surface of the image sensors.

The sensor wafer may then be thinned, as shown in block 502 (see FIG. 8B). A layer of a stress film 606 is formed over at least one surface of the thinned sensor wafer 804 (block 504 and FIG. 8C). Next, as shown in block 508, the layer of the stress film on at least one surface of the sensor wafer is patterned into a predetermined pattern (FIG. 8D). In the illustrated embodiment, if more than one layer of a stress film is formed over the image sensor, each layer of a stress film may be patterned after the layer is formed over the sensor wafer. In other embodiments, more than one layer of the same stress film or of different stress films can be formed over the sensor wafer and the layers patterned at one time. The layers may be patterned in a single patterning process or multiple patterning processes can be performed to pattern the stress films.

A determination may then be made at block 506 as to whether or not another layer of a stress film will be formed over at least one surface of the sensor wafer. If so, the process returns to block 504. When another layer of a stress film will not be formed over at least one surface of the sensor wafer, the method continues at block 704 where a dicing die attach film (DDAF) 810 is attached to the patterned stress film(s). In one embodiment, a frame 812 can support the assembly of the support wafer 800, the sensor wafer 804, the patterned stress film 808, and the DDAF 810 (FIG. 8E). The support wafer 800 is removed and the image sensors singulated, as shown in blocks 707 and 708 (see also FIG. 8F).

As described earlier, the one or more layers of stress film 816 on the image sensor 814 produces a stress imbalance in the image sensor substrate, which causes the substrate to bend or curve. A curved image sensor is shown in FIG. 8G.

In embodiments where a stress film is to be formed over the surface that the support wafer will affix to (e.g., the surface corresponding to the light receiving surfaces of the image sensors), a stress film can be formed over that surface of the sensor wafer and patterned at block 514 prior to temporarily bonding the support wafer to the sensor wafer. The stress film may include one or more layers of the same or of different types of a stress film. After the layer or layers of stress films have been formed over the surface and patterned, the method may pass to block 700.

Although the method of FIG. 7 is described as patterning all of the layers in a stress film, it will be appreciated that one or more layers of a stress film may not patterned when a stress film includes multiple layers. Thus, some but not all of the layers in the stress film may be patterned to produce the desired bend or curve in an image sensor. Additionally or alternatively, a single layer of a stress film on a surface of the image sensor can be formed with two or more different types of stress films. As one example, one type of a stress film can be formed around the periphery of an image sensor and another type of stress film may be formed inside the periphery. The different types of stress films may or may not be patterned.

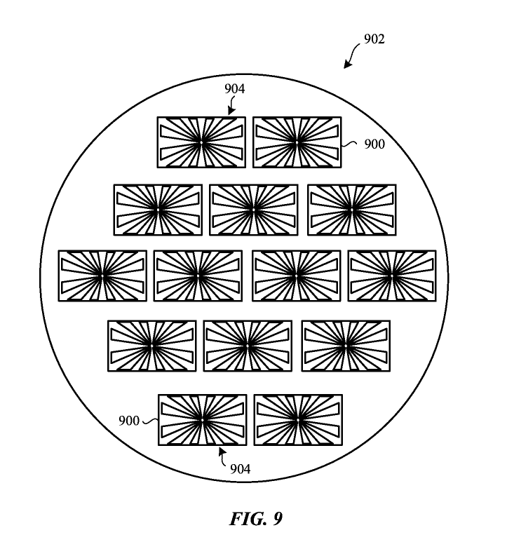

Referring now to FIG. 9, there is shown one example of a patterned stress film formed over a sensor wafer. Multiple image sensors 900 are formed in and/or on the sensor wafer 902, and each image sensor includes a patterned stress film 904 formed over a surface of the image sensor. As shown in FIG. 9, the pattern in the patterned stress film is the same pattern for all of the image sensors 900.

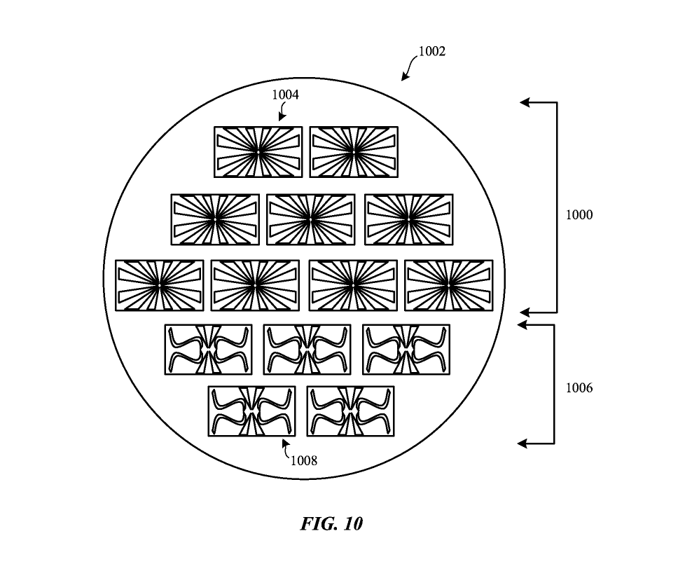

FIG. 10 illustrates one example of different patterned stress films formed over a sensor wafer. Some of the image sensors 1000 on the sensor wafer 1002 include a patterned stress film having a first pattern 1004 while other image sensors 1006 include a patterned stress film that has a different second pattern 1008. Thus, regions of a sensor wafer can include different patterned stress films. Additionally or alternatively, regions of one or more image sensors can include different patterned stress films.

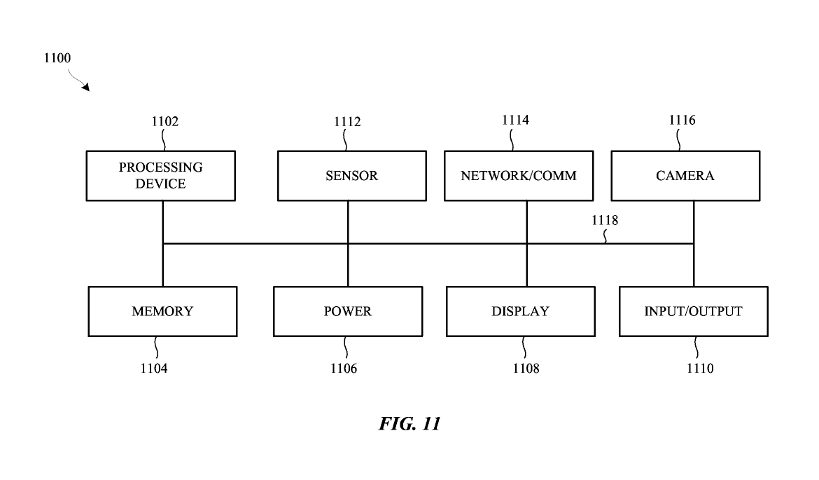

Referring now to FIG. 11, there is shown a block diagram of an electronic device that may include the image capture system shown in FIG. 2. The electronic device 1100 can include one or more processors 1102, storage or memory components 1104, a power source 1106, a display 1108, input/output interface 1110, one or more sensors 1112, a network communication interface 1114, and one or more cameras 1116, each of which will be discussed in turn below.

The one or more processors 1102 can control some or all of the operations of the electronic device 1100. The processor(s) 1102 can communicate, either directly or indirectly, with substantially all of the components of the electronic device 1100. For example, one or more system buses 1118 or other communication mechanisms can provide communication between the processor(s) 1102, the storage or memory components 1104, the power source 1106, the display 1108, the input/output interface 1110, the sensor(s) 1112, the network communication interface 1114, and the one or more cameras 1116. The processor(s) 1102 can be implemented as any electronic device capable of processing, receiving, or transmitting data or instructions. For example, the one or more processors 1102 can be a microprocessor, a central processing unit (CPU), an application-specific integrated circuit (ASIC), a digital signal processor (DSP), or combinations of multiple such devices. As described herein, the term “processor” is meant to encompass a single processor or processing unit, multiple processors, multiple processing units, or other suitably configured computing element or elements.

The memory 1104 can store electronic data that can be used by the electronic device 1100. For example, the memory 1104 can store electrical data or content such as, for example, audio files, document files, timing signals, algorithms, and image data. The memory 1104 can be configured as any type of memory. By way of example only, memory 1104 can be implemented as random access memory, read-only memory, Flash memory, removable memory, or other types of storage elements, in any combination.

The power source 1106 can be implemented with any device capable of providing energy to the electronic device 1100. For example, the power source 1106 can be a battery or a connection cable that connects the electronic device 1100 to another power source such as a wall outlet.

The display 1108 may provide an image or video output for the electronic device 1100. The display 1108 can be substantially any size and may be positioned substantially anywhere on the electronic device 1100. In some embodiments, the display 1108 can be a liquid display screen, a plasma screen, or a light emitting diode screen. The display 1108 may also function as an input device in addition to displaying output from the electronic device 1100. For example, the display 1108 can include capacitive touch sensors, infrared touch sensors, or the like that may capture a user's input to the display. In these embodiments, a user may press on the display 1108 in order to provide input to the electronic device 1100.

The input/output interface 1110 can receive data from a user or one or more other electronic devices. The I/O interface 1110 can include a display, a touch sensing input surface such as a track pad, one or more buttons, one or more microphones or speakers, one or more ports such as a microphone port, and/or a keyboard.

The one or more sensors 1112 can by implemented with any type of sensor. Examples of sensors include, but are not limited to, light sensors such as light emitting sensors and/or light detection sensors, audio sensors (e.g., microphones), gyroscopes, and accelerometers. Example light emitting sensors include, but are not limited to light-emitting diode (LED) sensors and vertical-cavity, surface emitting laser. Example light detection sensors include, but are not limited to, sensors that include optical or photodetectors such as photodiodes and photoresistors. The sensor(s) 1112 can be used to provide data to the processor 1102, which may be used to enhance or vary functions of the electronic device.

The network communication interface 1114 can facilitate transmission of data to a user or to other electronic devices. For example, in embodiments where the electronic device 1100 is a smart telephone, the network communication interface 1114 can receive data from a network or send and transmit electronic signals via a wireless or wired connection. Examples of wireless and wired connections include, but are not limited to, cellular, WiFi, Bluetooth, and Ethernet. In one or more embodiments, the network communication interface 1114 supports multiple network or communication mechanisms. For example, the network communication interface 1114 can pair with another device over a Bluetooth network to transfer signals to the other device while simultaneously receiving signals from a WiFi or other wired or wireless connection.

The one or more cameras 1116 can be used to capture images or video. In some embodiments, a camera may include a global shutter configured curved image sensor or a rolling shutter configured curved image sensor. The image sensor can be implemented as any suitable image sensor, such as a complementary metal-oxide-semiconductor (CMOS) image sensor. The camera(s) include an optical system that is in optical communication with the curved image sensor. As described earlier, the optical system can include conventional elements such as a lens, a filter, an iris, and a shutter. Various elements of the camera 1116, such as the optical system and/or the image sensor, can be controlled by timing signals or other signals supplied from the processor 1102 and/or the memory 1104.

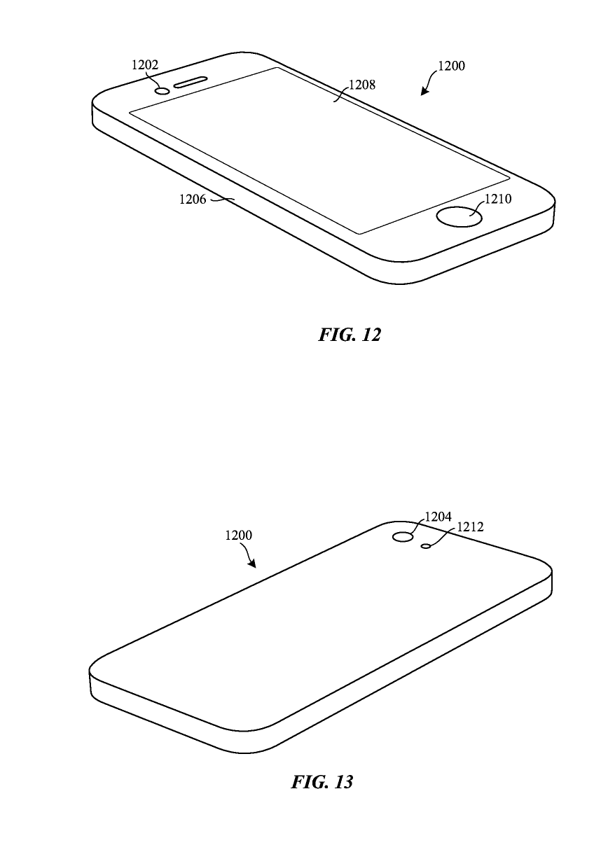

FIGS. 12 and 13 are perspective front and rear views of an example electronic device that can include one or more curved image sensors. The electronic device 1200 includes a first camera 1202, a second camera 1204, an enclosure 1206, a display 1208, an input/output (I/O) device 1210, and an optional flash 1212 or light source for the camera or cameras. The electronic device 1200 can also include one or more internal components (not shown) typical of a computing or electronic device, such as, for example, one or more processors, memory components, network interfaces, and so on. For example, the electronic device 1200 can include the components shown in FIG. 11.

In the illustrated embodiment, the electronic device 1200 is implemented as a smart telephone. Other embodiments, however, are not limited to this construction. Other types of computing or electronic devices can include one or more cameras, including, but not limited to, a netbook or laptop computer, a tablet computing device, a digital camera, a wearable electronic or communication device, a scanner, a video recorder, and a copier.

As shown in FIGS. 12 and 13, the enclosure 1206 can form an outer surface or partial outer surface and protective case for the internal components of the electronic device 1200, and may at least partially surround the display 1208. The enclosure 1206 can be formed of one or more components operably connected together, such as a front piece and a back piece. Alternatively, the enclosure 1206 can be formed of a single piece operably connected to the display 1208.

The display 1208 can be operably or communicatively connected to the electronic device 1200. The display 1208 can be implemented with any type of suitable display, such as a retina display, a color liquid crystal display (LCD), or an organic light-emitting display (OLED). The display 1208 can provide a visual output for the electronic device 1200 or function to receive user inputs to the electronic device. For example, the display 1208 can be a multi-touch capacitive sensing touchscreen that can detect one or more user touch and/or force inputs.

The I/O device 1210 can be implemented with any type of input or output device. By way of example only, the I/O device 1210 can be a switch, a button, a capacitive sensor, or other input mechanism. The I/O device 1210 allows a user to interact with the electronic device 1200. For example, the I/O device 1210 may be a button or switch to alter the volume, return to a home screen, and the like. The electronic device can include one or more input device and/or output devices, and each device can have a single I/O function or multiple I/O functions. Examples include microphone, speakers, touch sensor, network or communication ports, and wireless communication devices. In some embodiments, one or more touch sensors can be included in the I/O device 1210 and/or in the display 1208.

Various embodiments have been described in detail with particular reference to certain features thereof, but it will be understood that variations and modifications can be effected within the spirit and scope of the disclosure. Even though specific embodiments have been described herein, it should be noted that the application is not limited to these embodiments. In particular, any features described with respect to one embodiment may also be used in other embodiments, where compatible. Likewise, the features of the different embodiments may be exchanged, where compatible.

We claim:

1. A curved light sensor, comprising:
a light sensor comprising a light receiving surface and a non-light receiving surface; and
a patterned stress film formed over at least one surface of the light sensor.

2. The curved light sensor as in claim 1, wherein the curved light sensor comprises a light emitting sensor.

3. The curved light sensor as in claim 1, wherein the curved light sensor comprises a light detection sensor.

4. The curved light sensor as in claim 3, wherein the light detection sensor comprises an image sensor.

4. The curved light sensor as in claim 1, wherein the patterned stress film is formed over the non-light receiving surface.

5. The curved light sensor as in claim 4, wherein the patterned stress film is formed over the light receiving surface.

6. The curved light sensor as in claim 1, wherein the patterned stress film is formed over the light receiving surface.

7. The curved light sensor as in claim 1, wherein the patterned stress film comprises a single layer of a stress film.

8. The curved light sensor as in claim 1, wherein the patterned stress film comprises multiple layers of stress films.

9. The curved light sensor as in claim 8, wherein at least one layer of a stress film in the multiple layers of stress films is a different type of stress film than another layer of a stress film in the multiple layers of stress films.

10. The curved light sensor as in claim 8, wherein at least one layer of a stress film in the multiple layers of stress films is patterned differently than another layer of a stress film in the multiple layers of stress films.

11. A method for producing a curved light sensor, comprising:
attaching a support wafer to a first surface of a sensor wafer, wherein the sensor wafer includes multiple light sensors and the first surface corresponds to a light receiving surface of the multiple light sensors;
forming a stress film over a second surface of the sensor wafer;
forming a pattern in the stress film over each light sensor; and
removing the support wafer from the first surface of the sensor wafer.

12. The method as in claim 11, further comprising attaching a dicing die attach film over the patterned stress film prior to removing the support wafer.

13. The method as in claim 12, further comprising singulating the light sensors after the support wafer is removed, wherein each light sensor includes a respective patterned stress film between the dicing die attach film and the second surface of the light sensor.

14. The method as in claim 11, further comprising thinning the sensor wafer prior to forming the stress film over the second surface of the sensor wafer.

15. The method as in claim 11, wherein the pattern in the stress film over each light sensor is formed using photolithography.

16. The method as in claim 11, wherein the pattern formed in the stress film over each light sensor comprises an identical pattern over each light sensor.

17. The method as in claim 11, wherein the pattern formed in the stress film over each light sensor comprises at least two different patterns, wherein one pattern is formed over a first portion of the light sensors and another pattern is formed over a second portion of the light sensors.

18. The method as in claim 11, further comprising:
prior to attaching a support wafer to a first surface of a sensor wafer, forming a stress film over the first surface of the sensor wafer; and
forming a pattern in the stress film.

19. The method as in claim 11, wherein the curved light sensor comprises a curved image sensor, and wherein the multiple light sensors comprise multiple image sensors.

20. A method for producing a curved light sensor, comprising:
attaching a dicing tape to a first surface of a sensor wafer, wherein the sensor wafer includes multiple light sensors;
forming a stress film over a second surface of the sensor wafer;
forming a pattern in the stress film over each light sensor; and
singulating the light sensors, wherein each light sensor includes a respective patterned stress film over the second surface of the light sensor.

21. The method as in claim 20, further comprising removing the dicing tape.

22. The method as in claim 20, further comprising thinning the sensor wafer prior to forming the stress film over the second surface of the sensor wafer.

23. The method as in claim 20, wherein the pattern in the stress film is formed using photolithography.

24. The method as in claim 20, wherein the pattern formed in the stress film over each light sensor comprises an identical pattern over each light sensor.

25. The method as in claim 20, wherein the pattern formed in the stress film over each light sensor comprises at least two different patterns, wherein one pattern is formed over a first portion of the light sensors and another pattern is formed over a second portion of the light sensors.

26. The method as in claim 20, further comprising:
prior to attaching a dicing tape to a first surface of a sensor wafer, forming a stress film over the first surface of the sensor wafer; and
forming a pattern in the stress film.

27. The method as in claim 20, wherein the curved light sensor comprises a curved image sensor, and wherein the multiple light sensors comprise multiple image sensors.

28. An optical assembly, comprising:
a curved light sensor, comprising:
a light sensor comprising a light receiving surface and a non-light receiving surface; and
a patterned stress film formed over at least one surface of the light sensor; and
an optical system in optical communication with the curved light sensor, wherein the optical system is configured to optimize light received by the light receiving surface of the light sensor.
